(19) United States
(12) Patent Application Publication
(10) Pub. No.: US 2026/0354467 A1
(43) Pub. Date: Nov. 12, 2026

(54) HEATER FOR AN AEROSOL PROVISION DEVICE

(71) Applicant: Nicoventures Trading Limited, London (GB)

(72) Inventors: Tom WOODMAN, London (GB); Juan Esteban Paz JAUREGUI, London (GB); Mark POTTER, London (GB); Theodora NANNOU, London (GB)

(21) Appl. No.: 19/125,033

(22) PCT Filed: Oct. 24, 2023
(86) PCT No.: PCT/EP2023/079608

§ 371 Date: Apr. 28, 2025

(30) Foreign Application Priority Data
Oct. 31, 2022 (GB) 2216153.3

(51) Int. Cl. A24F 40/46; A24F 40/70; H05B 3/44

(52) U.S. Cl. CPC A24F 40/46; A24F 40/70; H05B 3/44

(57) ABSTRACT

The application relates to a heater for an aerosol provision device. The device has an elongate housing. A heating coil is located in the housing defining a longitudinal axis. The heating coil has a varying diameter along the longitudinal length.

### CROSS-REFERENCE TO RELATED APPLICATIONS

This present application is a National Phase entry of PCT Application No. PCT/EP2023/079608, filed Oct. 24, 2023, which claims priority from Great Britian Application No. 2216153.3, filed Oct. 31, 2022, each of which are fully incorporated herein by reference in their entireties.

### TECHNICAL FIELD

The present invention relates to a heater for an aerosol provision device, an aerosol provision device, an aerosol provision system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium. Separately induction heating systems are known to be used as heaters.

### SUMMARY

According to an aspect there is provided a heater for an aerosol provision device comprising:
an elongate housing; and
a heating coil located in the housing defining a longitudinal axis, wherein the heating coil has a varying diameter along the longitudinal length.

It will be understood that according to various embodiments a heating coil may be provided which tapers or becomes narrower. Any void between the heating coil and the internal cavity of the elongate housing may be filled with a filler.

According to various embodiment the inner cavity may be at least partially filled with a filler material comprising a thermally insulating material. The thermally insulating material may comprise a polymeric material. The thermally insulating material may be a potting compound, an adhesive, thermosetting plastic or an epoxy resin. According to various embodiments the potting compound may comprise an epoxy resin. For example, a two-component epoxy may be used consisting of a polymer resin and a hardener which when mixed together causes a chemical reaction which cross-links chemical bonds in the polymer chains to create a tough, rigid and strong compound. Other embodiments are contemplated wherein the potting compound comprises a polyurethane (“PU”) e.g. a thermoset plastic. This may comprise a two-component compound consisting of a base resin with an isocyanate curing agent. Other embodiments are contemplated wherein the potting compound comprises a silicone. For example, silicone rubber may be utilised comprising a synthetic polysiloxane polymer that uses an additive catalyser (such as platinum) to transition from a liquid to a solid state.

The filler material may comprise one or more inorganic materials, such as glass, ceramic, magnesium oxide, aluminum oxide.

The heating coil may comprise a first section having one or more first turns and a second section having one or more second turns, wherein the one or more first turns may have a greater diameter than the one or more second turns.

The housing may comprise a base end and a free end, wherein the first section is disposed proximal the base end and the second section is disposed proximal the free end.

The heating coil may diametrically converge towards the free end. According to various embodiments, the diameter of the heating coil may narrow, taper or become smaller in a direction towards the free end. It will be appreciated that the diameter of the heating coil may become smaller or reduce when the heating coil is located within an inner cavity of the elongate housing and when viewed from a mouth end of the inner cavity towards a distal end of the inner cavity.

According to various embodiments the inner cavity of the elongate housing may comprise a conical or truncated conical profile and may taper or become narrower in a direction moving from a mouth end of the inner cavity to a distal end of the inner cavity. The heating coil may have a corresponding profile or similar profile i.e. the heating coil may have a diameter which becomes progressively narrower. The heating coil may be arranged to fit relatively tightly within the inner cavity. An outer surface of the heating coil may comprise an insulator or insulating layer. The insulator or insulating layer may comprise an electrical insulator. Embodiments are contemplated wherein the inner cavity of the heater comprises a socket or recess and the heating coil comprises a corresponding plug portion which fits securely into the socket or recess. Further embodiments are contemplated wherein at least an end portion of the heating coil may have a degree of flexibility and the inner cavity may have an internal profile such that the cavity tapers in a direction moving away from a mouth end of the cavity towards a distal end of the cavity, constricts to a certain narrowest diameter and then expands at the distal end. The heating coil may be inserted into the inner cavity and at least an end portion of the heating coil may compress as it is inserted past the narrowest diameter portion and then may expand into the distal end of the cavity. As a result, the heating coil may be held within the inner cavity of the elongate housing.

The heating coil may comprise one or more helical coils.

A radially outer dimension of the heating coil may vary along the longitudinal direction.

The elongate housing may comprise an inner cavity. The inner cavity may have a varying diameter along the longitudinal length.

The inner cavity may have a mouth end and a distal end. The diameter of the inner cavity may taper or become smaller in a direction from the mouth end to the distal end. The heating coil may have an outer profile which also tapers or becomes smaller in order to facilitate insertion of the heating coil into the inner cavity. The heating coil may have an outer profile which conforms to a profile of the inner cavity.

A radially outer dimension of the heating coil at a first end of the heating coil may be greater than a radially outer dimension of the heating coil at a second end of the heating coil.

An outer dimension of the heating coil may change between a first end of the heating coil and a second end of the heating coil in a substantially uniform and/or continuous manner so that an outer dimension of the heating coil progressively reduces from the first end to the second end.

An outer dimension of the heating coil may change between a first end of the heating coil and a second end of the heating coil in a substantially non-uniform manner so that an outer dimension of the heating coil reduces from the first end to the second end.

An outer dimension of the heating coil may change between a first end of the heating coil and a second end of the heating coil in a substantially non-uniform, discontinuous or stepped manner from the first end to the second end.

An outer dimension of the heating coil may change between a first end of the heating coil and a second end of the heating coil wherein in at least one longitudinal portion of the heating coil the outer dimension of the heating coil changes at a first rate of change and coil wherein in at least one longitudinal portion of the heating coil the outer dimension of the heating coil changes at a second rate of change, wherein the first rate of change is greater than the second rate of change.

The heating coil may have an outer dimension such that the heating coil has an outer profile, wherein the housing and the heating coil are configured so that the heating coil sits within an inner cavity between an alpha position and a beta position along the longitudinal extent of the inner cavity, wherein the surface of the heater defining the inner cavity between the alpha and beta positions substantially mirrors the outer profile of the heating coil.

The outer profile of the heating coil may be in contact with at least part of the surface of the heater defining the inner cavity between the alpha and beta positions.

The housing may be longitudinally extending and may have a first end and a second end, wherein an inner cavity extends between the first end of the housing and a third position, the first end of the housing defines a mouth through which the inner cavity may be accessed, wherein the alpha position is proximal the first end of the housing and the beta position is proximal the third position.

The heating coil may comprise M turns per unit of longitudinal length adjacent to a first end of the heating coil and N turns per unit of longitudinal length adjacent to a second end of the heating coil, wherein N≥M and wherein M≠0 and wherein N≠0.

The housing may have an outer surface and the housing may be so configured that the surface of the longitudinal portion of the housing which coincides with the longitudinal position of an inner cavity mirrors the longitudinal surface defining the inner cavity.

The heater may comprise a resistive heater.

The heating coil may comprise a resistive heating coil.

According to another aspect there is provided an aerosol provision device configured to heat an article comprising aerosol generating material, the device comprising a heater as described above.

According to another aspect there is provided a system comprising an aerosol provision device as described above and an article comprising aerosol generating material.

According to another aspect there is provided a method of generating an aerosol comprising:
providing an aerosol provision device as described above; and
at least partially inserting an aerosol generating article into a receiving portion of a heating chamber of the aerosol provision device.

The method may further comprise energising the aerosol provision device in order to generate an aerosol from the aerosol generating article.

According to another aspect there is provided a method of manufacturing or assembling a heater for an aerosol provision device comprising:
providing an elongate housing; and
locating or inserting a heating coil in the housing defining a longitudinal axis, wherein the heating coil has a varying diameter along the longitudinal length.

According to another various embodiments there is provided a method of manufacturing or assembling a heater for an aerosol provision device comprising:
providing an elongate housing, wherein the elongate housing comprises an inner cavity having a mouth end and a distal end, wherein the inner cavity tapers from the mouth end towards the distal end; and
inserting a heating coil into the inner cavity, wherein the heating coil has a diameter which tapers along a longitudinal length and wherein the heating coil is inserted into the inner cavity so that a portion of the heating coil having a diameter D1 is inserted adjacent the distal end and so that a portion of the heating coil having a diameter D2 is inserted adjacent the mouth end, wherein D2>D1.

The method may further comprise at least partially filling the inner cavity with a filler material either before inserting the heating coil into the inner cavity and/or after inserting the heating coil into the inner cavity.

The heater may be a resistive heating heater.

The heating member may be a resistive heating member.

The heating element may be a resistive heating element.

The coil may be a resistive heating heater coil.

The heater may be an inductive heating heater.

The heating element may be an inductive heating element.

The coil may be an inductive coil.

According to an aspect there is provided aerosol provision device configured to heat an article comprising aerosol generating material, the device comprising a heater described above. The aerosol provision device may comprise a heating chamber, in which the heater is provided.

The aerosol provision device may comprise a power source, a controller and a heating chamber, in which the aerosol generating article is removeable received. The power source may be aligned along a longitudinal axis of the heating chamber. The power source may be aligned along a second longitudinal axis, parallel to the longitudinal axis of the heating chamber.

The aerosol provision device may be configured for wireless charging.

According to an aspect there is provided an aerosol provision system comprising: an aerosol provision device as described above; and an article comprising aerosol generating material.

The aerosol provision system may comprise a charging unit having a cavity for removably receiving the aerosol provision device. The charging unit may comprise a moveable lid, which covers the aerosol provision device in a closed configuration. The charging unit may comprise a user display. The user display may be visible to a user when the moveable lid is in a closed position and is partially or fully concealed or obscured from sight by the lid when the lid is an open position.

According to another aspect there is provided a method of generating aerosol comprising: providing an aerosol provision device comprising as described above and at least partially inserting an aerosol generating article into the receiving portion of the heating chamber.

### BRIEF DESCRIPTION OF THE DRAWINGS

Various embodiments will now be described, by way of example only, and with reference to the accompanying drawings, in which:

FIG. 1 shows a perspective view of an aerosol provision system including an aerosol provision device located within a charging unit;

FIG. 2 shows a schematic cross-sectional view of part of the aerosol provision device of FIG. 1;

FIG. 3 shows a schematic cross-sectional view of part of the aerosol provision device of FIG. 1 and an aerosol generating article of the aerosol provision system;

FIG. 4 shows a perspective view of another aerosol provision device;

FIG. 5 shows a schematic cross-sectional view of the device of FIG. 4;

FIG. 6 shows a schematic cross-sectional view of a heater of the device of FIG. 1 or FIG. 4;

FIG. 7 shows a schematic cross-sectional view of a heater according to various embodiments;

FIG. 8 shows a schematic cross-sectional view of a heater according to various embodiments; and

FIG. 9 shows a method of manufacturing or assembling a heater according to various embodiments.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision device may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

As used herein, the term “aerosol-generating material” is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol-generating material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales. The article may be, for example, of a predetermined or specific size that is configured to be placed within or over a heater of the device which is sized to receive the article.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

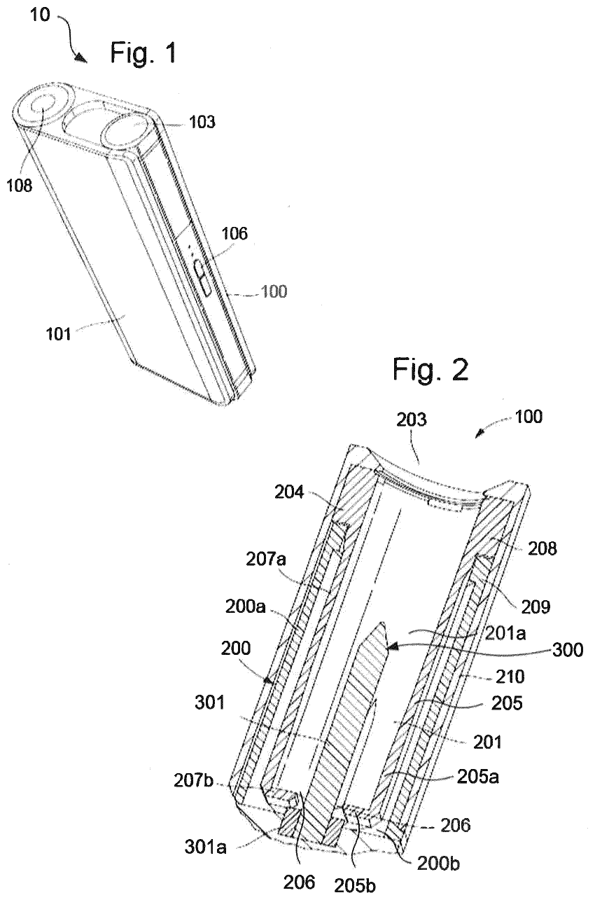

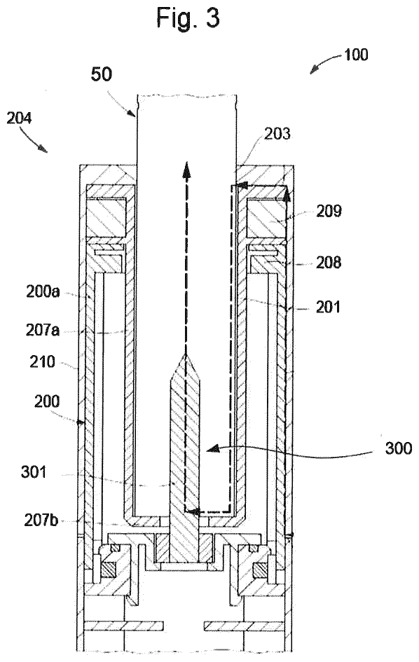

FIG. 1 shows an aerosol provision system 10 comprising an aerosol provision device 100 and a charging unit 101. The device is shown located within a cavity of a charging unit 101. The aerosol provision device 100 is arranged to generate aerosol from an aerosol generating article (refer to FIG. 3) which may be inserted, in use, into the aerosol provision device 100. In embodiments, the article forms part of the aerosol provision system 10.

The aerosol provision device 100 is an elongate structure, extending along a longitudinal axis. Additionally, the aerosol provision device has a proximal end, which will be closest to the user (e.g. the user's mouth) when in use by the user to inhale the aerosol generated by the aerosol provision device 100, as well as a distal end which will be furthest from the user when in use. The proximal end may also be referred to as the “mouth end”. The aerosol provision device 100 also accordingly defines a proximal direction, which is directed towards the user when in use. Further, the aerosol provision device 100 also likewise defines a distal direction, which is directed away from the user when in use. The terms proximal and distal as applied to features of the device 100 will be described by reference to the relative positioning of such features with respect to each other in a proximal-distal direction along a longitudinal axis. The aerosol provision device 100 comprises an opening at the distal end, leading into a heating chamber.

The aerosol provision device 100 may be removably inserted into the charging unit 101 in order to be charged. The charging unit 101 comprises a cavity for receiving the aerosol provision device 100. The aerosol provision device 100 may be inserted into the cavity via an opening. The cavity may also comprise a longitudinal opening. A portion of the aerosol provision device 100 may comprise a first side. One or more user-operable control elements such as buttons 106 which can be used to operate the aerosol provision device 100 may be provided on the first side of the aerosol provision device 100. The first side of the aerosol provision device 100 may be received in the longitudinal opening provided in the charging unit 101.

In embodiments the cavity of the charging unit 101 may have a cross-sectional profile which only permits that the aerosol provision device 100 be inserted into the charging unit 101 in a single orientation. According to an embodiment the outer profile of the aerosol provision device 100 may comprise an arcuate portion and a linear portion. The cross-sectional profile of the cavity provided in the charging unit 101 may also comprise a similar arcuate portion and a linear portion. The linear portion of the cross-sectional profile of the cavity may correspond with the longitudinal opening.

The charging unit 101 includes a slidable lid 103. When the aerosol provision device 100 is inserted into the charging unit 101 in order to be recharged, the slidable lid 103 may be closed so as to cover the opening into the aerosol provision device 100. In other embodiments, the charging unit 101 may have an alternative lid configuration, such as a hinged or pivoted lid, or no lid may be provided.

The charging unit 101 may include a user interface such as display 108, which can be provided at any convenient location, such as in the position shown in FIG. 1.

FIG. 2 shows a cross sectional view of a portion of the aerosol provision device 100. The aerosol provision device 100 comprises a main housing 200. The main housing 200 defines a device body of the device 100. The device 100 defines a heating chamber 201. A receptacle 205 defines the heating chamber 201. An opening 203 is provided to provide access to the heating chamber 201. The receptacle 205 comprises a wall arrangement including a receptacle side wall 205a and a receptacle base 205b. The base 205b is at the distal end of the receptacle 205. A heating zone 201a is configured at least a portion of the article for heating.

A heating member 301 is provided in a portion of the main housing 200 and the heating member 301 extends or projects into the heating chamber 201. The heating member 301 may comprise a base portion 301a which may be located in a recess provided in a portion of the body of the device 100. The heating member 301 upstands in the heating chamber 201. The heating member 301 upstands from the distal end.

The heating member 301 comprises an elongate heating member in the form of a pin. The heating member 301 in other embodiments comprises other elongate configurations, such as a blade. The heating member 301 may be inserted, in use, into a distal end of an aerosol generating article 50 (refer to FIG. 3) which is received within the heating chamber 201 in order to internally heat the aerosol generating article 50.

The housing comprises housing wall 200a. The housing wall 200a extends along the longitudinal axis of the aerosol provision device 100, surrounding the heating chamber 201. The housing wall 200a may, at least in part, define a receiving chamber of the aerosol provision device 100, as the volume which is enclosed within the wall 200a. A housing base 200b is at the distal end of the housing wall 200a. In the shown embodiment, the heating member 301 upstands from the housing base 200b. The heating member 301 protrudes through the receptacle base 205b. An aperture 206 is formed in the receptacle base 205b through which the heating member 301 protrudes. In embodiments, the heating member 301 is mounted to the receptacle base 205b. The heating member 301 upstands from the receptacle base 205b.

The aerosol provision device 100 further comprises a removal mechanism 204 which may be removably retained to the main housing 200 of the aerosol provision device 100. The removal mechanism 204 in embodiments is omitted. In embodiments, the housing wall 200a at least in part defines the receptacle 205. The removal mechanism 204 may be retained to the main housing 200 so that at least a portion of the removal mechanism 204 extends into the heating chamber 201. The removal mechanism 204 may comprise a longitudinal portion such as a peripheral wall portion 207a, which in the present embodiment is tubular, and a base wall portion 207b. The wall 207a may be a shape other than tubular, and may be any shape which encloses (e.g. encircles) and defines the heating chamber 201 there within.

In embodiments with the removal mechanism 204, the removal mechanism 204 defines the heating chamber 201. The removal mechanism 204 forms the receptacle 205. In embodiments in which the removal mechanism 204 is omitted, other features of the device 100 define the heating chamber 201, for example the housing side wall 200a and housing base 200b.

The base portion 207b has the aperture 206 through which the heating member 301 may project. In order to retain the removal mechanism 204 to the main housing 200, the removal mechanism 204 is pushed into engagement with the main housing 200 in the distal direction, i.e. towards the distal end of the main housing 200, until the removal mechanism 204 is able to move no further in the distal direction. In the following description, when the removal mechanism 204 is referred to as being “retained to” the main housing 200, this is when the removal mechanism 204 is engaged with the main housing 200, and can move no further in the distal direction.

Together, the peripheral portion 207a and the base portion 207b may define and enclose an article chamber for receiving, the aerosol generating article 50, as shown in FIG. 3. The article chamber comprises an inner surface, which is configured to contact the aerosol generating article, the inner surface comprising a longitudinally extending portion which is provided by the tubular portion 207a, and an end portion which is provided by the base portion 207b. In embodiments, the article chamber and the heating chamber are the same. When the aerosol generating article 50 is received in the heating chamber, it may contact both the longitudinally extending portion of the inner surface, and the end portion of the inner surface. In particular, the article chamber (i.e. the peripheral portion 207a and the base portion 207b) may be configured to receive at least part of the aerosol generating article 50 which is in the form of rod which is longitudinally extending and cylindrical, such that the longitudinal axis of the article is parallel to (and optionally in line with) the longitudinal axis of the aerosol provision device 100 when received in the article chamber.

The article chamber may also be referred to as a receiving portion. When the removal mechanism 204 is retained to the main housing 200, in use, the article chamber of the removal mechanism 204 is arranged, at least partially, within the heating chamber 201. The heating member 301 may be arranged so as to project into the article chamber, through the aperture 206 provided in the base portion 207b of the removal mechanism 204. The removal mechanism 204 is therefore configured to receive at least a portion of the aerosol generating article in use.

In embodiments, the removal mechanism 204 may comprise a first magnet or a magnetisable material 208. The main housing 200 may comprise a second magnet or magnetisable material 209. In use, the removal mechanism 204 may be magnetically retained to the main housing 200 by the interaction of the first magnet or magnetisable material 208 and the second magnet or magnetisable material 209.

In embodiments, the removal mechanism 204 is fully detachable from the main housing 200. The removal mechanism 204 may be retained to the main housing 200 by a magnetic force of attraction between the first magnet or magnetisable material 208 and the second magnet or magnetisable material 209. The removal mechanism 204 may be detached from the main housing 200 by overcoming the magnetic force between the first magnet or magnetisable material 208 and the second magnet or magnetisable material 209. In embodiments, the removal mechanism 204 is removably retained to the main housing 200 by other means. For example, the removal mechanism 204 may be configured to be removably retained to the main housing 200 by an interference fit with the main housing.

The removal mechanism 204 may comprise an internal element (comprising the tubular portion 207a and a base portion 207b) and an outer cap portion 210, wherein when retained to the main housing 200 the outer cap portion 210 encapsulates (e.g. covers) at least a portion of the main housing 200, such as the wall 200a of the main housing. The tubular portion 207a, base portion 207b and outer cap portion 210 may comprise an integral (e.g. unitary) component (formed, for example, by moulding). Alternatively, the tubular portion 207a and base portion 207b may comprise a first component and the outer cap portion 210 may comprise a second separate component. The first and second components may then be secured together.

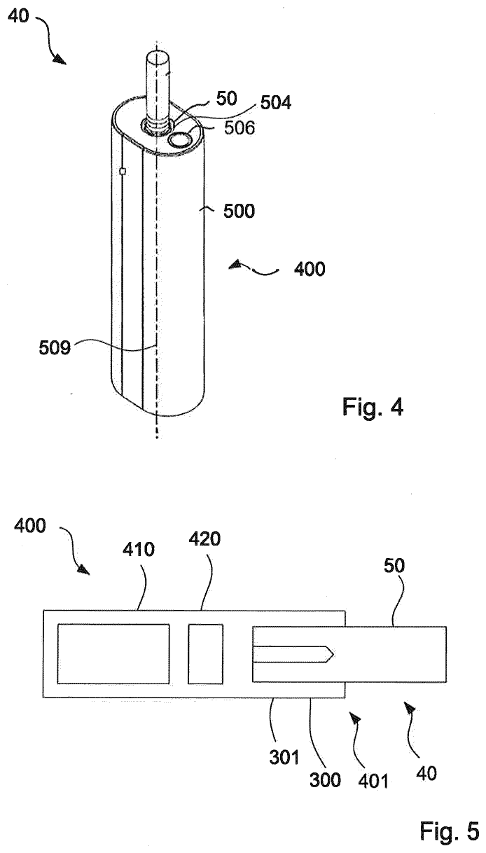

FIG. 4 shows another aerosol provision system 40. The system 40 comprises a one-piece aerosol provision device 400 for generating aerosol from an aerosol generating material, and the aerosol generating article 50 comprising the aerosol generating material. The device 400 can be used to heat the aerosol generating article 50 comprising the aerosol generating material, to generate an aerosol or other inhalable medium which can be inhaled by a user of the device 400.

The device 400 comprises a housing 500 which surrounds and houses various components of the device 400. The housing 500 is elongate. The device 400 has an opening 504 in one end, through which the article 50 can be inserted for heating by the device 400. The article 50 may be fully or partially inserted into the device 400 for heating by the device 400.

The device 400 may comprise a user-operable control element 506, such as a button or switch, which operates the device 400 when operated, e.g. pressed. For example, a user may activate the device 400 by pressing the switch 406.

The device 400 defines a longitudinal axis 509 along which an article 50 may extend when inserted into the device 400. The opening 504 is aligned on the longitudinal axis 509.

FIG. 5 shows a cross-sectional schematic view of the aerosol provision system 40. Features described with reference to FIG. 5 in embodiments are applicable to embodiments described above. The aerosol provision device comprises a power source 410, a controller 420 and a heating chamber 401, in which the aerosol generating article 50 is removeable received.

The one-piece device of FIG. 5 shows the power source 410 aligned along the longitudinal axis of the heating chamber 401. In another embodiment of a one-piece aerosol generating device, the power source is aligned along a second longitudinal axis, parallel to the longitudinal axis of the heating chamber.

The heating member 301 comprises an elongate heating member in the form of a pin. The heating member 301 in embodiments comprises other elongate configurations, such as a blade. The heating member 301 is provided in the heating chamber. The heating member 301 of FIG. 5 and the heating member 301 described above with reference to FIGS. 1 to 3, such that details described herein may be applied to each. The heating member 301 extends or projects into the heating chamber 401.

The heating member 301 may be inserted, in use, into a distal end of the aerosol generating article 50 which is received within the heating chamber 401 in order to internally heat the aerosol generating article 50.

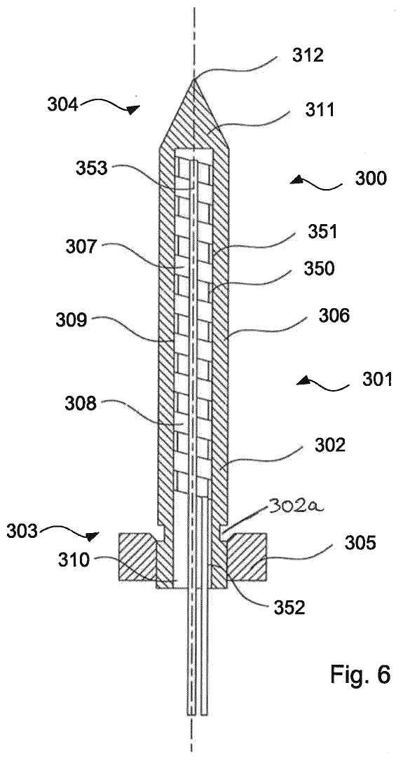

The aerosol provision devices 100, 400 comprise a heating arrangement 300. The heating arrangement 300 comprises a heater. The heating member 301 acts as the heater. The heater comprises a heating element 350 (refer to FIG. 6), such as a resistive heating coil, arranged to be actuated to heat the heating member 301.

The heating arrangement 300 is a resistive heating arrangement. The heater is a resistive heating heater. The heating element, such as a heating coil, as will be described below is a resistive heating element. In such arrangements the heating assembly comprises a resistive heating generator including components to heat the heating element via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement comprises electrical contacts for supplying electrical current to the resistive material. In embodiments, the heating element forms at least part of the resistive heating member itself. In embodiments the resistive heating element transfers heat to the heating member, for example by conduction. The provision of a resistive heating arrangement allows for a compact arrangement. Resistive heating provides an efficient configuration.

FIG. 6 shows the heating member 301 for use in an aerosol provision device as described above. The heating member 301 acts as or forms at least part of a heater. The heating arrangement 300 comprises the heating member 301. The heating member 301 comprises an elongate housing 302 and the heating element 350. The elongate housing 302 is an elongate member defining a longitudinal axis.

The elongate housing 302 is formed from a thermally conductive material, such as aluminium. Other suitable materials such as stainless steel may be used. The elongate housing may comprise a coating on its outer surface. The elongate housing 302 is configured to transfer heat from the heating element 350 to the heating zone 201a.

The elongate housing 302 has a base end 303 and a free end 304. The base end 304 mounts to the device body. A mount 305 at the base end 303 mounts the heating member 301. It will be understood that different mounting arrangements may be used, for example a fixing, moulding and bonding including adhering. The mount 305 may be a separate component or may be integrally formed with the elongate housing 302.

The elongate housing 302 comprises a housing body 306. The housing body 306 is tubular. The housing body 306 comprises a bore 307. The bore 307 defines an inner void 308 of the heating member 301. The inner void 308 extends longitudinally. In embodiments, the inner void 308 is at least partially filled, for example with a filler. In embodiments, the inner void 308 is completely filled, for example with one or more fillers and/or components. In embodiments, the inner void 308 defines an air gap. An inner surface 309 is defined on an inner side of the elongate housing 302. An open end 310 to the inner void 308 is provided at the base end 303.

The free end 304 of the elongate housing 302 extends towards the proximal end of the heating chamber. The free end 304 of the heating member 301 is closed. The inner void 308 does not extend through the free end 304. A tip 311 is provided at the free end 304. The tip 311 extends to an apex 312. Other shapes and configurations of the tip 311 may be provided, for example the tip 311 may define a planar surface.

The heating element 350 extends in the heating member 301. The heating element 350 extends in the elongate housing 302 in the longitudinal direction. The heating element 350 is received in the inner void 308. The heating element 350 extends between the base end 303 and the distal end 304. In embodiments, the heating element extends partially along the length of the inner void 308. In embodiments the heating element 350 extends to or beyond the open end 310.

The heating element 350 in embodiments comprises a heating coil 351. The heating coil 351 comprises a resistive member defining the heating coil 351. In embodiments the heating coil 351 comprises an electrically insulative coating, such as a ceramic, to electrically insulate the heating coil 351 from the elongate housing 302. The electrically insulative coating in embodiments is thermally conductive to provide for heat transfer from the heating element 350 to the elongate housing 302. In embodiments the electrically insulative coating is omitted. In embodiments, a separate electrically insulative arrangement, such as at least one of an electrically insulative member and an electrically insulative filler is provided. The electrically insulative member and electrically insulative filler in embodiments is thermally conductive to provide for heat transfer from the heating element 350 to the elongate housing 302.

The heating coil 351 is a resistive heating coil. The heating coil 351 is a helical coil. The heating coil 351 has a rectangular cross-sectional profile. It will be understood that other coil configurations are possible. In embodiments, the heating coil 351 has a circular cross-sectional profile. In embodiments, the heating arrangement 300 comprises two or more heating coils.

The heating arrangement 300 comprises electrical connection paths. The electrical connection paths extend from each end of the heating element 350. A base electrical connection path 352 extends from the distal end of the heating element 350. A return electrical connection path 353 extends from the proximal end of the heating element 350. The return electrical connection path overlaps the longitudinal extent of the heating element 350. The electrical connection paths 352,352 are integrally formed with the heating element 350, for example as a single wire. In embodiments, connectors connect the electrical connection paths 352,353 with the heating element 350. The heating coil 351 is formed from a resistive material, such as a nickel/chrome alloy such as nichrome 80/20(80 % nickel, 20% chromium), an iron/chrome/aluminium alloy or a copper/nickel alloy.

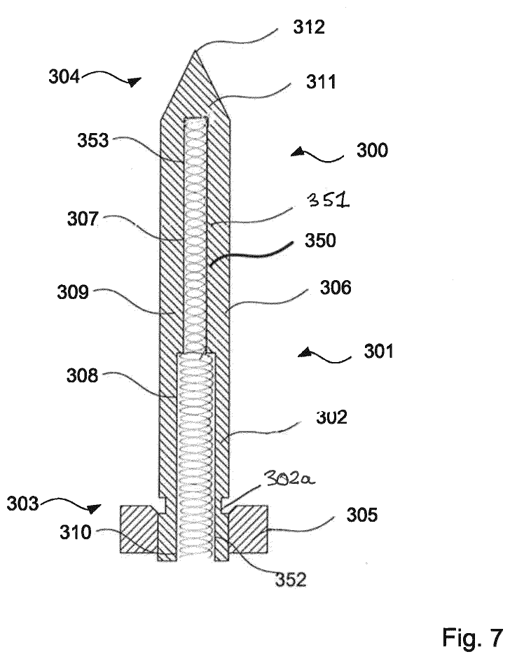

FIG. 7 shows a heating member 301 for an aerosol provision device according to various embodiments. The heating member 301 may be used in aerosol provision devices as describe above. The heating member 301 may act as or form at least part of a heater. The heating member 301 comprises an elongate housing 302 and a heating element 350. The elongate housing 302 may comprise an elongate member defining a longitudinal axis. The longitudinal axis may be parallel with the longitudinal axis of the aerosol provision device. The longitudinal axis may coincide with the longitudinal axis of the aerosol provision device.

According to various embodiments a heater for an aerosol provision device is provided. The heater comprises an elongate housing 302 and a heating coil located in the housing defining a longitudinal axis. The heating coil has a varying diameter along the longitudinal length.

According to various embodiments a heating coil may be provided which has a varying diameter which facilitates insertion of the heating coil into an inner cavity of an elongate housing 302. The inner cavity may have a mouth end and the outer profile of the heating coil may be arranged to correspond with the internal profile of the inner cavity. For example, the heating coil may be arranged to be inserted into the inner cavity and to sit relatively secure within the inner cavity. According to an embodiment the inner cavity may taper and become narrower in a direction moving away from the mouth end of the inner cavity. In a similar manner, the heating coil may have a corresponding profile.

It will be understood that according to various embodiments a heating coil may be provided which tapers or becomes narrower. The tapered profile of the heating coil is beneficial during assembly of the heating element. Any void between the heating coil and the internal cavity of the elongate housing 302 may be filled with a filler.

Since the heating coil varies in diameter along the longitudinal length, a heater may also be provided which has a heating profile which may vary according to position so as to create different heating zones. Alternatively, the variation in the diameter of the heating coil may be arranged so as to compensate for a temperature gradient which would otherwise exist along the length of the heater. Accordingly, embodiments are contemplated wherein the heater may have a more uniform heating profile along the length of the heater. As a result, an aerosol provision device incorporating the heater may provide an improved user experience and/or more efficient utilisation of aerosol generating material.

The heater according to various embodiments is beneficial in terms of ease of assembly and may require a reduced amount of filler material to secure the heating coil within the elongate housing compared with other arrangements.

Accordingly, the cost of manufacture may be reduced and a more reliable heater for an aerosol provision device may be provided.

Embodiments are contemplated wherein the number of turns of the heating coil may vary with longitudinal position. In particular, the heating coil when inserted into the inner cavity may comprise a greater number of turns per unit length in a region proximal to the distal end of the inner cavity. For example, the heating coil may comprise a lesser number of turns per unit length towards the mouth end of the inner cavity. This may allow the heating profile to be further tailored along the length of the device to create different heating zones or to compensate for an otherwise existing temperature gradient and so provide a more uniform heating profile. This may result in an improved user experience and/or more efficient utilisation of aerosol generating material.

The inner cavity may have a mouth end and a distal end. The diameter of the inner cavity may taper or become smaller in a direction from the mouth end to the distal end. The heating coil may have an outer profile which also tapers or becomes smaller in order to facilitate insertion of the heating coil into the inner cavity. The heating coil may have an outer profile which conforms to a profile of the inner cavity. This aids heat transfer from the heating coil to a heating zone of the aerosol provision device.

An outer dimension of the heating coil may change between a first end of the heating coil and a second end of the heating coil in a substantially uniform and/or continuous manner so that an outer dimension of the heating coil progressively reduces from the first end to the second end. This may allow for a uniform and/or continuous variation in the temperature of the aerosol generating material, which may provide an improved user experience and/or more efficient utilization of the aerosol generating material.

An outer dimension of the heating coil may change between a first end of the heating coil and a second end of the heating coil in a substantially non-uniform manner so that an outer dimension of the heating coil reduces from the first end to the second end. This may allow for a simpler manufacturing process.

The heating coil may have an outer dimension such that the heating coil has an outer profile, wherein the housing and the heating coil are configured so that the heating coil sits within an inner cavity between an alpha position and a beta position along the longitudinal extent of the inner cavity, wherein the surface of the heater defining the inner cavity between the alpha and beta positions substantially mirrors the outer profile of the heating coil. This aids heat transfer from the heating coil to a heating zone of the aerosol provision device.

The outer profile of the heating coil may be in contact with at least part of the surface of the heater defining the inner cavity between the alpha and beta positions. This aids heat transfer from the heating coil to a heating zone of the aerosol provision device. Further, the arrangement of the housing and the profile of the heating coil enables a heater to be manufactured wherein the heating coil is securely held within the housing and reduced amount of filler material which may be used to fill the inner cavity.

The elongate housing 302 may be formed from a thermally conductive material, such as aluminium. Oher suitable materials such as stainless steel may be used. According to another embodiment the housing 302 may comprise a ceramic. The elongate housing 302 may comprise a coating on its outer surface. The elongate housing 302 is configured to transfer heat from the heating element 350 to a heating zone.

The elongate housing 302 has a base end 303 and a free end 304. The base end 304 may be mounted to a body portion of an aerosol provision device. A mount 305 may be provide at the base end 303 and may be used to mount the heating member 301. It will be understood that different mounting arrangements may be used, for example, fixing, moulding and bonding including adhering. The mount 305 may be a separate component or may be integrally formed with the elongate housing 302.

The elongate housing 302 comprises a housing body 306. The housing body 306 may be tubular. The housing body 306 may comprise a bore 307. The bore may have a circular cross section. Alternatively, the bore may have a different cross section. The bore 307 may partially define an inner void 308 of the heating member 301. The inner void 308 extends longitudinally. In embodiments, the inner void 308 is at least partially filled, for example with a filler. In embodiments, the inner void 308 is completely filled, for example with one or more fillers and/or components.

According to various embodiments the inner cavity or inner void 308 may be at least partially filled with a filler material comprising a thermally insulating material. The thermally insulating material may be a potting compound, an adhesive, thermosetting plastic or an epoxy resin. According to various embodiments the potting compound may comprise an epoxy resin. For example, a two-component epoxy may be used consisting of a polymer resin and a hardener which when mixed together causes a chemical reaction which cross-links chemical bonds in the polymer chains to create a tough, rigid and strong compound. Other embodiments are contemplated wherein the potting compound comprises a polyurethane (“PU”) e.g. a thermoset plastic. This may comprise a two-component compound consisting of a base resin with an isocyanate curing agent. Other embodiments are contemplated wherein the potting compound comprises a silicone. For example, silicone rubber may be utilised comprising a synthetic polysiloxane polymer that uses an additive catalyser (such as platinum) to transition from a liquid to a solid state.

According to various embodiments, the inner void 308 may define an air gap. An inner surface 309 may be defined on an inner side of the elongate housing 302. An open end 310 to the inner void 308 may be provided at the base end 303.

The inner void 308 may have a varying diameter along the longitudinal axis. It will be understood that the diameter of the inner void 308 may be the same as the diameter of the bore 307 and inner surface 309. The diameter of the inner void 308 may vary discontinuously along the longitudinal axis. The inner void 308 may have a first section and a second section. In the first section, the diameter of the inner void 308 may be constant along the longitudinal axis. In the second section, the diameter of the inner void 308 may also be constant along the longitudinal axis. The diameter of the inner void 308 in the first section may be greater than the diameter of the inner void 308 in the second section. In other embodiments, the diameter of the inner void 308 may vary continuously along the longitudinal axis. For example, the inner surface 309 may be substantially conical or frusto-conical.

The free end 304 of the elongate housing 302 may extend towards the proximal end of a heating chamber. The free end 304 of the heating member 301 may be closed. According to various embodiments, the inner void 308 does not extend through the free end 304. A tip 311 is provided at the free end 304. The tip 311 extends to an apex 312. Other shapes and configurations of the tip 311 may be provided, for example the tip 311 may define a planar surface. Other embodiments are contemplated wherein the inner void 308 does extend through the free end 304, but once the heating coil 351 has been inserted into the inner void 308, the aperture in the free end 304 may be filled with a filler material.

According to various embodiments, a heating element 350 is provided which extends in the heating member 301. The heating element 350 extends in the elongate housing 302 in the longitudinal direction. The heating element 350 is received in the inner void 308. The heating element 350 extends between the base end 303 and the distal end 304. In embodiments, the heating element extends partially along the length of the inner void 308. In embodiments the heating element 350 extends to or beyond the open end 310.

The heating element 350 may comprise a heating coil 351 or another type of resistive heating element. The heating coil 351 may comprise a resistive member defining the heating coil 351. In embodiments the heating coil 351 may comprise an electrically insulative coating, such as a ceramic, to electrically insulate the heating coil 351 from the elongate housing 302. The electrically insulative coating may be thermally conductive in order to provide for heat transfer from the heating element 350 to the elongate housing 302. In embodiments the electrically insulative coating may be omitted. In embodiments, a separate electrically insulative arrangement, such as at least one of an electrically insulative member and an electrically insulative filler may be provided. The electrically insulative member and electrically insulative filler may be thermally conductive to provide for heat transfer from the heating element 350 to the elongate housing 302.

The heating coil 351 may comprise one or more resistive heating coils. The one or more heating coils 351 may comprise a helical coil. For example, two heating coils having different diameters may be connected to each other in series. The heating coil 351 may comprise wires or electrodes which have a rectangular, oval, circular or polygonal cross-sectional profile. It will be understood that other coil configurations are possible. In embodiments, the heating coil 351 may have a circular cross-sectional profile which varies at different axial positions. In embodiments, the heating arrangement 300 may comprises two, three, four or more than four heating coils. The heating coils may be interconnected by wires or electrodes.

The heating arrangement 300 may comprise one or more electrical connection paths. The electrical connection paths may extend from each end of the heating element 350. A base electrical connection path 352 may extend from a proximal end of the heating element 350. A return electrical connection path 353 may extend from a distal end of the heating element 350. The return electrical connection path may overlap the longitudinal extent of the heating element 350. The electrical connection paths 352,353 may be formed integrally with the heating element 350, for example as a single wire or conductor. In embodiments, connectors may be arranged to connect the electrical connection paths 352,353 with the heating element 350. The heating coil 351 may be formed from a resistive material, such as a nickel/chrome alloy such as nichrome 80/20 (80% nickel, 20% chromium), an iron/chrome/aluminium alloy or a copper/nickel alloy.

An outer dimension of the heating coil 351 may vary along the longitudinal direction. The outer dimension may be a radially outer dimension. The outer dimension may be an outer diameter of the heating coil 351. The outer dimension may be a maximum width of the heating coil 351. Embodiments are described below with reference to the diameter of the heating coil 351 or part of the heating coil 351, but it will be understood that embodiments are also envisaged in which the heating coil 351 has a non-circular cross-section, and references to the diameter may be taken to include any outer dimension of the heating coil 351.

The diameter of the heating coil 351 at a first end of the heating coil 351 may be greater than the diameter of the heating coil 351 at a second end of the heating coil 351. The first end is proximal to the base end 303. The second end is proximal to the free end 304. The heating coil 351 may diametrically converge towards the free end 304. In other words, the diameter of the heating coil 351 may be narrower towards the free end 304. The diameter of the heating coil 351 may change between the first end of the heating coil 351 and the second end of the heating coil 351 in a substantially non-uniform manner so that the diameter of the heating coil 351 may reduce from the first end to the second end. The diameter of the heating coil 351 may reduce in a stepped manner in a direction from the base end 303 towards the free end 304. The heating coil 351 may comprise a first section and a second section. The first section may be disposed proximal the base end 303 and the second section may be disposed proximal the free end 304. The first section may have a plurality of first turns and the second section may have a plurality of second turns. The first turns have a greater diameter than the second turns.

The heating coil 351 may comprise a first helical coil and a second helical coil. The first and second helical coils may be provided as a single one-piece component. As used herein, one-piece component refers to a component which is not separable into two or more components following assembly. The first and second helical coils may be integrally formed. As used herein, integrally formed refers to two or more features that are formed into a one-piece component during a manufacturing stage of the component. In other embodiments, the first and second helical coils may be separate components. The first helical coil may be located towards the base end 303. The second helical coil may be located towards the free end 304. The first coil may define the first section. The second coil may define the second section. In embodiments, the heating coil 351 may comprise three or more helical coils. In embodiments, the heating coil may comprise a single helical coil of varying diameter.

In other embodiments, the outer diameter of the heating coil 351 may reduce in a continuous manner in a direction from the base end 303 towards the free end 304. In embodiments, the heating coil 351 may comprise a single helical coil of varying diameter. In such embodiments, the outer diameter of the heating coil 351 may change between the first end of the heating coil 351 and the second end of the heating coil 351 in a substantially uniform and/or continuous manner so that an outer diameter of the heating coil 351 progressively reduces from the first end to the second end.

As shown in FIG. 7, the inner void 308 and the heating coil 351 may have a similar profile. The heating coil 351 may have an outer profile which may be determined by the outer dimension of the heating coil 351. The housing 302 and the heating coil 351 may be configured so that the heating coil 351 sits within the inner cavity 308 between an alpha position and a beta position along the longitudinal extent of the inner cavity 308. The inner surface 309 between the alpha and beta positions may substantially mirror the outer profile of the heating coil 351. The outer profile of the heating coil 351 may be in contact with at least part of the inner surface 309 between the alpha and beta positions. The alpha position is proximal the base end 303 of the housing and the beta position is proximal the free end 304.

In embodiments, in at least one longitudinal portion of the heating coil 351, the diameter of the heating coil 351 may change at a first rate of change and in at least one longitudinal portion of the heating coil 351 the diameter of the heating coil 351 may change at a second, greater, rate of change. In embodiments, the heating coil 351 may comprise M turns per unit of longitudinal length adjacent to the first end of the heating coil and N turns per unit of longitudinal length adjacent to the second end of the heating coil, wherein N≥M and wherein M 16 0 and wherein N≠0. Other embodiments are contemplated wherein M≥N and wherein M≠0 and wherein N≠0

An outer surface of the longitudinal portion of the housing 302 which coincides with the longitudinal position of the inner cavity 308 may be arranged to mirror the inner surface 309.

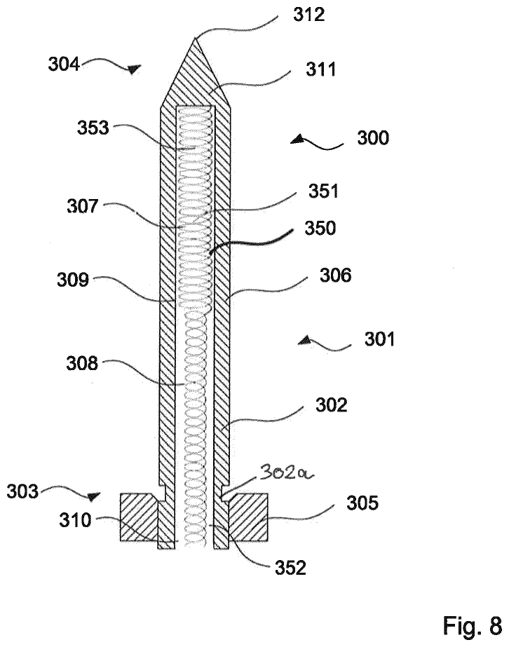

FIG. 8 shows an alternative embodiment wherein an outer diameter of the heating coil 351 increases in a direction away from the base end 303 towards the free end 304 of the heater. The heating member 301 of FIG. 8 may be used in aerosol provision devices as described above. The heating member 301 may act as or form at least part of a heater. The heating member 301 may comprise an elongate housing 302 and a heating element 350. The elongate housing 302 may comprise an elongate member defining a longitudinal axis. The longitudinal axis may be parallel with the longitudinal axis of the aerosol provision device 100. The longitudinal axis may coincide with the longitudinal axis of the aerosol provision device 100.

The elongate housing 302 may be formed from a thermally conductive material, such as aluminium or stainless steel. The elongate housing 302 may comprise a coating on its outer surface. The elongate housing 302 may be configured to transfer heat from the heating element 350 to a heating zone. The elongate housing 302 has a base end 303 and a free end 304. The base end 304 mounts to the device body. A mount 305 at the base end 303 mounts the heating member 301. It will be understood that different mounting arrangements may be used, for example a fixing, moulding and bonding including adhering. The mount 305 may be a separate component or may be integrally formed with the elongate housing 302.

A groove 302a or region of reduced cross-sectional diameter may be provided in the elongate housing 302 towards the base end 303 of the elongate housing 302. As will be discussed in more detail below, a heating coil 351 is located within an inner void 308 of the heating member 301. The groove 302a or region of reduced cross sectional diameter may be located, for example, along the length of the elongate housing 302 at a longitudinal position which is intermediate a first longitudinal position corresponding to the longitudinal position of an end of the heating coil 351 closest to the base end 303 and a second longitudinal position corresponding to the longitudinal position where a base end of the elongate housing 302 attaches to, abuts or is otherwise secured to the mount 305.

It will be understood that the groove 302a or region of reduced cross-sectional diameter reduces, restricts or diminishes the effect of heat conduction from the main body of the heating member 301 to the base end of the heating member 301 which is mounted to the mount 305. As a result, the flow of heat or thermal energy from the heating member 301 into the mount 305 is reduced. The groove 302a or region of reduced cross-sectional diameter can therefore be considered as having the function of acting as a thermal break which reduces heat bleed from the heating member 301 into the mount 305 or more generally into a mounting point.

Further embodiments are contemplated (not shown) wherein more than one groove or region of reduced cross-sectional diameter may be provided in the elongate housing to act as a thermal break. Although the groove 302a or region of reduced cross-sectional diameter is shown in FIG. 6 as comprising an annular recess, wherein the annular recess has a rectangular cross-sectional profile, other embodiments are contemplated wherein the annular recess may have a different cross-sectional profile such as, for example, a V-notch or W-notch. Further embodiments are also contemplated wherein one or more grooves or regions of reduced cross-sectional diameter may be provided on an inner surface of the elongate housing 302.

The elongate housing 302 comprises a housing body 306. The housing body 306 is tubular. The housing body 306 comprises a bore 307. In this embodiment, the bore has a circular cross section. In other embodiments, the bore may have any other cross section. The bore 307 defines an inner void 308 of the heating member 301. The inner void 308 extends longitudinally. In embodiments, the inner void 308 is at least partially filled, for example with a filler. In embodiments, the inner void 308 is completely filled, for example with one or more fillers and/or components. In embodiments, the inner void 308 defines an air gap. An inner surface 309 is defined on an inner side of the elongate housing 302. An open end 310 to the inner void 308 is provided at the base end 303. A diameter of the inner void 308 is constant along its longitudinal extent.

The free end 304 of the elongate housing 302 extends towards the proximal end of the heating chamber. The free end 304 of the heating member 301 is closed. The inner void 308 does not extend through the free end 304. A tip 311 is provided at the free end 304. The tip 311 extends to an apex 312. Other shapes and configurations of the tip 311 may be provided, for example the tip 311 may define a planar surface.

The heating element 350 extends in the heating member 301. The heating element 350 extends in the elongate housing 302 in the longitudinal direction. The heating element 350 is received in the inner void 308. The heating element 350 extends between the base end 303 and the distal end 304. In embodiments, the heating element extends partially along the length of the inner void 308. In embodiments the heating element 350 extends to or beyond the open end 310.

The heating element 350 in embodiments comprises a heating coil 351. The heating coil 351 comprises a resistive member defining the heating coil 351. In embodiments the heating coil 351 comprises an electrically insulative coating, such as a ceramic, to electrically insulate the heating coil 351 from the elongate housing 302. The electrically insulative coating in embodiments is thermally conductive to provide for heat transfer from the heating element 350 to the elongate housing 302. In embodiments the electrically insulative coating is omitted. In embodiments, a separate electrically insulative arrangement, such as at least one of an electrically insulative member and an electrically insulative filler is provided. The electrically insulative member and electrically insulative filler in embodiments is thermally conductive to provide for heat transfer from the heating element 350 to the elongate housing 302.

The heating coil 351 may comprise a resistive heating coil. The heating coil 351 may comprise a helical coil. The heating coil 351 may have a rectangular cross-sectional profile. It will be understood that other coil configurations are possible. In embodiments, the heating coil 351 has a circular cross-sectional profile. In embodiments, the heating arrangement 300 comprises two or more heating coils.

The heating arrangement 300 may comprise electrical connection paths. The electrical connection paths may extend from each end of the heating element 350. A base electrical connection path 352 extends from the proximal end of the heating element 350. A return electrical connection path 353 extends from the distal end of the heating element 350. The return electrical connection path may overlap the longitudinal extent of the heating element 350. The electrical connection paths 352,353 may be integrally formed with the heating element 350, for example as a single wire. In embodiments, connectors may connect the electrical connection paths 352,353 with the heating element 350. The heating coil 351 may be formed from a resistive material, such as copper.

An outer dimension of the heating coil 351 may vary along the longitudinal direction. The outer dimension is a radially outer dimension. The outer dimension is an outer diameter of the heating coil 351. In other embodiments, the outer dimension may be a maximum width of the heating coil 351.

The diameter at a first end of the heating coil 351 may be less than the diameter of the heating coil 351 at a second end of the heating coil 351. The first end is proximal to the base end 303. The second end is proximal to the free end 304. The heating coil 351 may diametrically diverge towards the free end 304. The diameter of the heating coil 351 may change between the first end of the heating coil 351 and the second end of the heating coil 351 in a substantially non-uniform manner so that the diameter of the heating coil 351 increases from the first end to the second end. The diameter of the heating coil 351 may increase in a stepped manner in a direction from the base end 303 towards the free end 304. The heating coil 351 comprises a first section and a second section. The first section is disposed proximal the base end 303 and the second section is disposed proximal the free end 304. The first section has a plurality of first turns and the second section has a plurality of second turns. The first turns may have a smaller diameter than the second turns.

The heating coil 351 may comprise a first helical coil and a second helical coil. The first and second helical coils may be provided as a single one-piece component. As used herein, one-piece component refers to a component which is not separable into two or more components following assembly. The first and second helical coils are integrally formed. As used herein, integrally formed refers to two or more features that are formed into a one-piece component during a manufacturing stage of the component. In other embodiments, the first and second helical coils may be separate components. The first helical coil may be located towards the base end 303. The second helical coil may be located towards the free end 304. The first coil may define the first section. The second coil may define the second section. In embodiments, the heating coil 351 may comprise three or more helical coils. In embodiments, the heating coil comprises a single helical coil of varying diameter.

In other embodiments, the outer diameter of the heating coil 351 may increase in a continuous manner in a direction from the base end 303 towards the free end 304. In embodiments, the heating coil 351 may comprise a single helical coil of varying diameter. In such embodiments, the outer diameter of the heating coil 351 may change between the first end of the heating coil 351 and the second end of the heating coil 351 in a substantially uniform and/or continuous manner so that an outer diameter of the heating coil 351 progressively increases from the first end to the second end.

In embodiments, in at least one longitudinal portion of the heating coil 351, the diameter of the heating coil 351 may change at a first rate of change and in at least one longitudinal portion of the heating coil 351 the diameter of the heating coil 351 may change at a second, greater, rate of change.

In embodiments, the heating coil comprises M turns per unit of longitudinal length adjacent to the first end of the heating coil and N turns per unit of longitudinal length adjacent to the second end of the heating coil, wherein N≥M and wherein M≠0 and wherein N≠0. Alternatively, M≥N and wherein M≠0 and wherein N≠0. An outer surface of the longitudinal portion of the housing 302 may coincide with the longitudinal position of the inner cavity 308 and may mirror the inner surface 309.

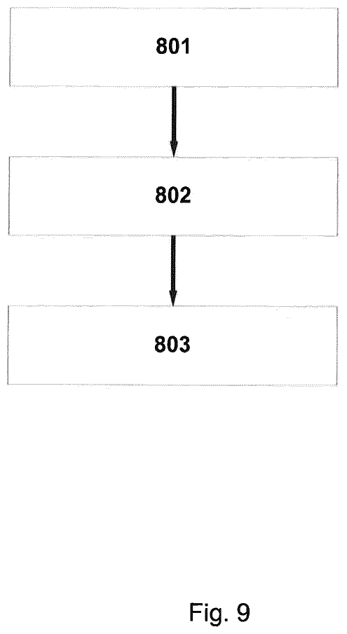

FIG. 9 illustrates a method of manufacturing a heater for an aerosol provision device according to various embodiments. The method may comprise a first step 801 of providing an elongate housing and a second step 802 of locating a heating coil in the housing defining a longitudinal axis, wherein the heating coil has a varying diameter along the longitudinal length. The method may include an optional third step 803 of inserting filler material into the inner cavity provided in the housing in order to further secure the heating coil within the inner cavity.

According to various embodiment the inner cavity may be at least partially filled with a filler material comprising a thermally insulating material. The thermally insulating material may be a potting compound, an adhesive, thermosetting plastic or an epoxy resin. According to various embodiments the potting compound may comprise an epoxy resin. For example, a two-component epoxy may be used consisting of a polymer resin and a hardener which when mixed together causes a chemical reaction which cross-links chemical bonds in the polymer chains to create a tough, rigid and strong compound. Other embodiments are contemplated wherein the potting compound comprises a polyurethane (“PU”) e.g. a thermoset plastic. This may comprise a two-component compound consisting of a base resin with an isocyanate curing agent. Other embodiments are contemplated wherein the potting compound comprises a silicone. For example, silicone rubber may be utilised comprising a synthetic polysiloxane polymer that uses an additive catalyser (such as platinum) to transition from a liquid to a solid state.

In the above described embodiments, the heating arrangement is a resistive heating arrangement. In embodiments, other types of heating arrangement are used, such as inductive heating. The configuration of the device is generally as described above and so a detailed description will be omitted.

An inductive heating arrangement comprises various components to heat the aerosol generating material of the article via an inductive heating process. Induction heating is a process of heating an electrically conducting heating member (such as a susceptor) by electromagnetic induction. An induction heating arrangement may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating member) suitably positioned with respect to the inductive element. In inductive heating, as compared to heating by conduction for example, heat is generated inside the susceptor, allowing for rapid heating. Further, there need not be any physical contact between the inductive element and the susceptor, allowing for enhanced freedom in construction and application.

In inductive heating heat is generated in the susceptor (heating member) whereas in resistive heating heat is generated in the coil (heating element).

In embodiments, the heating member of the aerosol provision system is a part of the aerosol generating article, rather than being a part of the aerosol provision device. The heating element may be a resistive heating element, for example in the form of the resistive coil described above, which is provided as part of the aerosol generating article. Electrical connections may enable electric current to flow through the resistive heating element.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A heater for an aerosol provision device comprising:
an elongate housing; and
a heating coil located in the housing defining a longitudinal axis, wherein the heating coil has a varying diameter along the longitudinal length.

2. The heater as claimed in claim 1, wherein the heating coil comprises a first section having one or more first turns and a second section having one or more second turns, wherein the one or more first turns have a greater diameter than the one or more second turns.

3. The heater as claimed in claim 2, wherein the housing comprises a base end and a free end, wherein the first section is disposed proximal the base end and the second section is disposed proximal the free end.

4. The heater as claimed in claim 3, wherein the heating coil diametrically converges towards the free end.

5. (canceled)

6. The heater as claimed in claim 1, wherein a radially outer dimension of the heating coil varies along the longitudinal direction.

7. The heater as claimed in claim 1, wherein the elongate housing comprises an inner cavity.

8. The A heater as claimed in claim 7, wherein the inner cavity has a varying diameter along the longitudinal length.

9. The heater as claimed in claim 1, wherein a radially outer dimension of the heating coil at a first end of the heating coil is greater than a radially outer dimension of the heating coil at a second end of the heating coil.

10. The heater as claimed in claim 1, wherein an outer dimension of the heating coil changes between a first end of the heating coil and a second end of the heating coil in a substantially uniform and/or continuous manner so that an outer dimension of the heating coil progressively reduces from the first end to the second end.

11. (canceled)

12. The heater as claimed in claim 1, wherein an outer dimension of the heating coil changes between a first end of the heating coil and a second end of the heating coil in a substantially non-uniform, discontinuous or stepped manner from the first end to the second end.

13. The heater as claimed in claim 1, wherein an outer dimension of the heating coil changes between a first end of the heating coil and a second end of the heating coil wherein in at least one longitudinal portion of the heating coil the outer dimension of the heating coil changes at a first rate of change and wherein in at least one longitudinal portion of the heating coil the outer dimension of the heating coil changes at a second rate of change, wherein the first rate of change is greater than the second rate of change.

14. The heater as claimed in claim 1, wherein the heating coil has an outer dimension such that the heating coil has an outer profile, wherein the housing and the heating coil are configured so that the heating coil sits within an inner cavity between an alpha position and a beta position along the longitudinal extent of the inner cavity, wherein the surface of the heater defining the inner cavity between the alpha and beta positions substantially mirrors the outer profile of the heating coil.

15. The heater as claimed in claim 14, wherein the outer profile of the heating coil is in contact with at least part of the surface of the heater defining the inner cavity between the alpha and beta positions.

16. The heater as claimed in claim 14, wherein the housing is longitudinally extending and has a first end and a second end, wherein an inner cavity extends between the first end of the housing and a third position, the first end of the housing defines a mouth through which the inner cavity is accessed, wherein the alpha position is proximal the first end of the housing and the beta position is proximal the third position.

17. The heater as claimed in claim 1, wherein the heating coil comprises M turns per unit of longitudinal length adjacent to a first end of the heating coil and N turns per unit of longitudinal length adjacent to a second end of the heating coil, wherein N≥M and wherein M≠0 and wherein N≠0.

18. The heater as claimed in claim 1, wherein the housing has an outer surface, and the housing is so configured that the surface of the longitudinal portion of the housing which coincides with the longitudinal position of an inner cavity mirrors the longitudinal surface defining the inner cavity.

19. The heater as claimed in claim 1, wherein the heater comprises a resistive heating heater.

20. (canceled)

21. An aerosol provision device configured to heat an article comprising aerosol generating material, the device comprising the heater of claim 1.

22. A system comprising the aerosol provision device of claim 1 and an article comprising aerosol generating material.

23. (canceled)

24. (canceled)

25. A method of manufacturing or assembling a heater for an aerosol provision device comprising, the method comprising:
providing an elongate housing; and
locating or inserting a heating coil in the housing defining a longitudinal axis, wherein the heating coil has a varying diameter along the longitudinal length.
